(19) United States
(12) Patent Application Publication
(10) Pub. No.: US 2012/0182532 A1
(43) Pub. Date: Jul. 19, 2012

(54) AUTOMATIC FOCUS SYSTEM OF PROJECTOR

(75) Inventors: Sen-Yung Liu, Taichung City (TW); Chien-chih Hsiung, Taichung City (TW); Chen-Ren Yu, Taichung City (TW); Kuo-Liang Wen, Taichung City (TW); Yi-Chung Hung, Taichung City (TW); Chiao-Sen Hsu, Taichung City (TW); Chao-Yang Ke, Taichung City (TW); Keng-Hui Lin, Taichung City (TW); Fu-Shan Wu, Taichung City (TW)

(73) Assignee: AISA OPTICALCO., INC, Taichung City (TW)

(21) Appl. No.: 13/167,083

(22) Filed: Jun. 23, 2011

(30) Foreign Application Priority Data
Jan. 13, 2011 (TW) 100103715

(51) Int. Cl. G03B 3/10

(52) U.S. Cl. 353/101

(57) ABSTRACT

An automatic focus system of a projector includes a projecting module, an image catching module, a memory, a micro processor, and a focusing module. The projecting module has an image light source to provide image light, and a projecting lens to project the image light on a screen. The image catching module senses an image on the screen. The microprocessor calculates the sensed image to have a definition value of the image and save the definition value in the memory. The focusing module may move the projecting lens is moved along an optical axis under a control of microprocessor. The microprocessor compares the definition values to control the focusing module to move the cam to a position where the projector may project a clear image on the screen.

### BACKGROUND OF THE INVENTION

1. Field of the Invention

The present invention relates generally to a projector, and more particularly to an automatic focus system of a projector.

2. Description of the Related Art

Projectors are wildly used in business, education, and home life. In present days, portable micro-projectors are provided in market. Such projectors have a small size, and some of them are incorporated in camera, video camera, or cell phone.

To project a clear image on screen, user has to manually adjust the lens to a predetermined position on the optical axis to form the image on the screen, and that is so called “focusing”. Most of the conventional projectors are equipped with manual focus system.

For a large projector, the lens is big and heavy, and the distance of the movement of the lens for focusing is long so that to manually adjust the focus of such projector is not easy for some people. However, for a micro-projector, the size of the lens is very small, and the distance of the movement of the lens for focusing is very short as well, and that is very difficult for manual focusing.

A conventional automatic focus system, taught in Taiwan patent 200412469, includes a rangefinder to find the distance between the projector and the screen, and a stepper motor to move the lens to a predetermined position. Such automatic focus system cannot identify that the image on the screen is clear or not, and the rangefinder needs large power. It cannot used in a micro-projector.

### SUMMARY OF THE INVENTION

The primary objective of the present invention is to provide an automatic focus system of a projector, which can make sure of a clear image on the screen.

According to the primary objective of the present invention, an automatic focus system of a projector includes a projecting module, an image catching module, a memory, a micro processor, and a focusing module. The projecting module has an image light source to provide image light, and a projecting lens to project the image light on a screen. The projecting lens has a guiding portion. The image catching module has a sensor and a catching lens. The sensor senses an image on the screen through the catching lens and transforms the image into electric signals. The microprocessor receives the electric signals from the image catching module, and calculates the electric signals to have a definition value of the image and save the definition value in the memory. The focusing module has a cam including an axle and a cam face surrounding the axle, and a driving device electrically connected to the microprocessor to drive the cam to turn under a control of microprocessor. The guiding portion of the projecting lens is rested on the cam face of the cam that the projecting lens is moved along an optical axis when the cam turns. The microprocessor compares the definition values when the projecting lens is moved to different positions, and transmits a control signal according to a result of comparison of the definition values to the driving device of the focusing module to drive the cam in a predetermined direction for a predetermined angle.

In an embodiment, the focusing module further includes gears between the driving device and the cam that the driving device drives the cam to turn through the gears.

With the automatic focus system of the present invention, it may have the clearest image on the screen.

### BRIEF DESCRIPTION OF THE DRAWINGS

FIG. 1 is a perspective view of a preferred embodiment of the present invention;

FIG. 2 is a block diagram of the preferred embodiment of the present invention; and

FIG. 3 is a perspective view of the preferred embodiment of the present invention, showing the focusing module and the projecting lens.

### DETAILED DESCRIPTION OF THE INVENTION

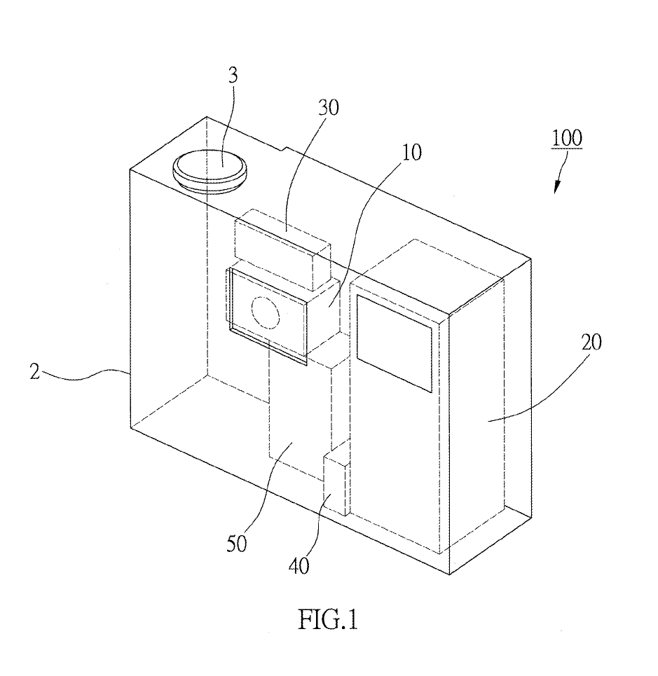

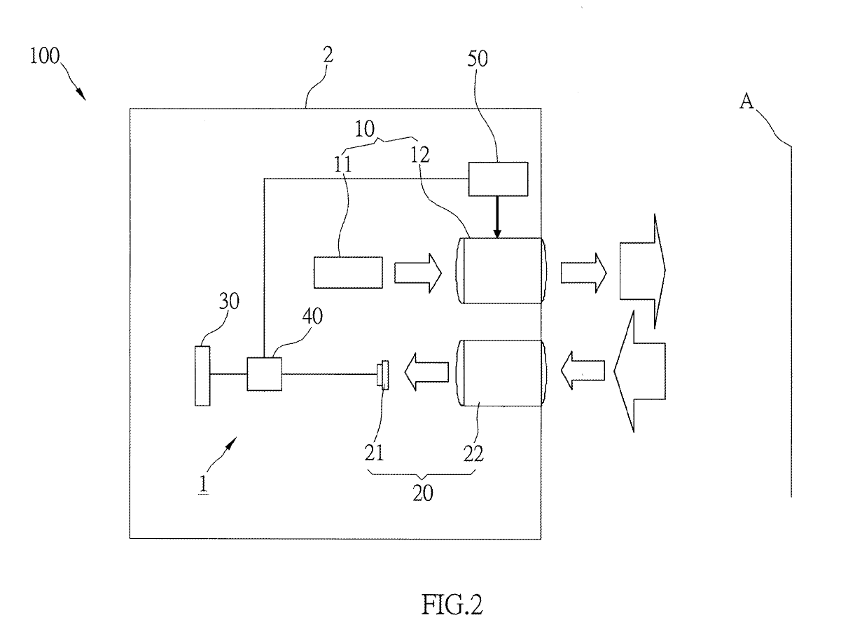

As shown in FIG. 1 and FIG. 2, a projector 100 of the preferred embodiment of the present invention includes a case 2, in which an automatic focus system 1 is provided. The automatic focus system 1 includes a projecting module 10, an image catching module 20, a memory 30, a microprocessor 40, and a focusing module 50.

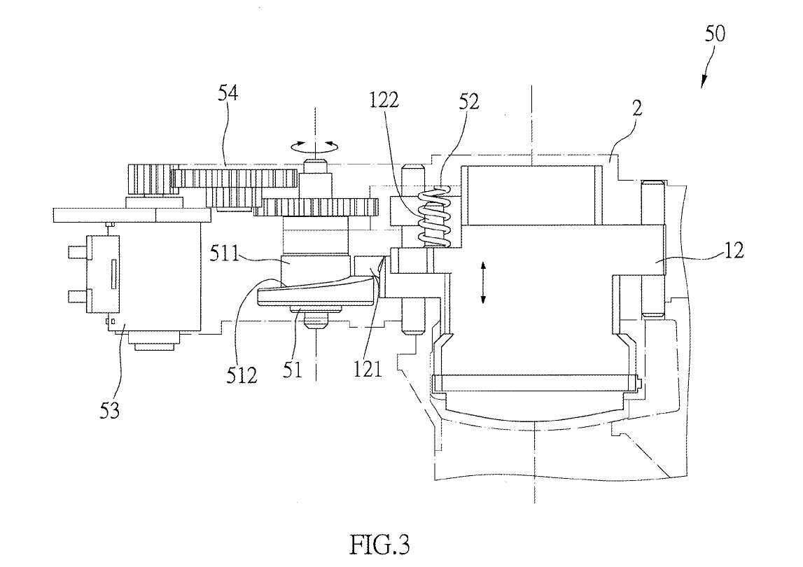

The projecting module 10 includes an image light source 11 and a lens 12. The image light source 11 is a conventional device to provide light for forming image. The projecting lens 12 is in front of the image light source 11 to form an image on a screen A. As shown in FIG. 3, the projecting lens 12 has a guiding portion 121 and a post 122. The guiding portion 121 is a protrusion on the projecting lens 12. The post 122 is projected from the projecting lens 12 with the distal end toward the case 2.

The image catching module 20 has a sensor 21 and a catching lens 22. The sensor 21 senses optical images and transforms them into electrical signals. The sensor 21 may be a charge-coupled device (CCD), complementary metal-oxide-semiconductor (CMOS), or other relative devices. The catching lens 22 forms the image on the screen A to the sensor 21.

The memory 30 is a flash memory or other relative devices.

The microprocessor 40 receives the electrical signals from the sensor 21 and calculates the signals to find a definition value of the image, and then saves the definition value in the memory 30. In the present invention, the microprocessor 40 calculates the contrast of the image to be the definition value. It is considered that it is a clear image on the screen A when the microprocessor 40 gets a high contrast, and it is an unclear image when the microprocessor 40 gets a low contrast. The microprocessor 40 also compares the definition values at different time, and generates a control signal according to the result of comparison.

As shown in FIG. 3, the focusing module 50 includes a cam 51, a spring 52, a driving device 53, and gears 54. The cam 51 has an axle 511 and a cam face 512 surrounding the axle 511. The cam face 512 has a predetermined terrain, such as an inclined face, or a curved face. The guiding portion 121 of the projecting lens 12 is rested on the cam face 512. The cam 51 may be turned by the axle 511.

The spring 52 is fitted onto the post 122 of the projecting lens 12. The spring 52 has opposite ends against the projecting lens 12 and the case 2 to press the guiding portion 121 on the cam face 512 of the cam 51. The spring 52 also may prevent the shifting or shaking problem.

The driving device 53 is a motor in the present invention to be electrically connected to the microprocessor 40. The microprocessor 40 controls the motor 53 to turn the cam 51, through the gears 54, in a predetermined direction and speed that the cam 51 may move the projecting lens 12 along the optical axis for focusing.

When the projector 100 of the present invention is turned on, it will project an image on the screen A through the light source 11 and the projecting lens 12, and then the automatic focusing system 1 may function. In practice, the projector 100 is provided with a button 3 to start the automatic focusing system 1.

The sensor 21 senses the image on the screen A through the catching lens 21, and transmits it to the microprocessor 40 to get a first definition value (the contrast) and save it in the memory 30.

Next, the microprocessor 40 controls the driving device 53 to move the projecting lens 12 along the optical axis in a first direction for a predetermined distance. And then, the image catching module 20 will activate again to senses the image (after the projecting lens 12 moved) on the screen A to get a second definition value. The direction of the movement of the projecting lens 12 may be toward a light modulator side (toward the light source 11) or toward a screen side (toward the projecting lens 12).

Next, the microprocessor 40 compares the second definition value with the first definition value. The microprocessor 40 controls the driving device 53 to move the projecting lens 12 in the first direction for another predetermined distance when the second definition value is greater than the first definition value. On the contrary, the microprocessor 40 controls the driving device 53 to move the projecting lens 12 in a second direction, which is opposite to the first direction, for a predetermined distance when the second definition value is less than the first definition value, and the distance moved in the second direction is greater than the distance moved in the first direction. The second definition value is saved in the memory 30.

Repeat the above automatic focusing steps, including sensing the definition value of the image on the screen A, comparing the definition value with the latest definition value saved in the memory 30, and moving the projecting lens 12 in the same direction as the last movement when the new sensed definition value is greater than the latest definition value saved in the memory 30.

When microprocessor 40 finds that the new sensed definition value is less than or equal to the latest definition value saved in the memory 30, it means that the image now on the screen A is clearest, and the automatic focusing procedure will be stopped to keep the projecting lens 12 at the present position.

Another method of automatic focus is moving the projecting lens 12 for a predetermined distance, and getting a definition value of an image on the screen A, and repeating above steps until the projecting lens 12 has moved through all of a range of the optical axis that the projecting lens 12 may arrive to get a series of definition values, and then finding the greatest definition value, and moving the projecting lens 12 to a position where it may get the greatest definition value. It is so called “global search”. A third method of automatic focus is using “Fibonacci search”. The projecting lens 12 will be moved to get definition values of images on the screen A to get values of the present definition value minus the previous definition value. The projecting lens 12 will be turned and moved in an opposite direction when the present value is positive and the previous value is negative, or present value is negative and the previous value is positive. A distance of the movement of the projecting lens 12 is less than a distance of the previous movement to reach the position having the highest definition value.

The description above is a few preferred embodiments of the present invention. These equivalences of the present invention are still in the scope of claim construction of the present invention.

What is claimed is:

1. An automatic focus system of a projector, comprising:
a projecting module having an image light source to provide image light, and a projecting lens to project the image light on a screen, wherein the projecting lens has a guiding portion;
an image catching module having a sensor and a catching lens, wherein the sensor senses an image on the screen through the catching lens and transforms the image into electric signals;
a memory;
a microprocessor receiving the electric signals from the image catching module, and calculating the electric signals to have a definition value of the image and save the definition value in the memory; and
a focusing module having a cam including an axle and a cam face surrounding the axle, and a driving device electrically connected to the microprocessor to drive the cam to turn under a control of microprocessor, wherein the guiding portion of the projecting lens is rested on the cam face of the cam that the projecting lens is moved along an optical axis when the cam turns;
wherein the microprocessor compares the definition values when the projecting lens is moved to different positions, and transmits a control signal according to a result of comparison of the definition values to the driving device of the focusing module to drive the cam in a predetermined direction for a predetermined angle.

2. The automatic focus system as defined in claim 1, wherein the sensor is a charge-coupled device.

3. The automatic focus system as defined in claim 1, wherein the sensor is a complementary metal-oxide-semiconductor.

4. The automatic focus system as defined in claim 1, further comprising a button on the projector to start the automatic focus system.

5. The automatic focus system as defined in claim 1, wherein the focusing module further includes gears between the driving device and the cam that the driving device drives the cam to turn through the gears.

6. The automatic focus system as defined in claim 1, wherein the cam face is an inclined face.

7. The automatic focus system as defined in claim 1, wherein the cam face is a curved face.
